(19) United States
(12) Patent Application Publication
(10) Pub. No.: US 2009/0112722 A1
(43) Pub. Date: Apr. 30, 2009

(54) CENTRALIZED CONSUMER NOTIFICATION SYSTEM

(75) Inventor: Michael L. Williams, Grand Rapids, MI (US)

Correspondence Address: MILLER, CANFIELD, PADDOCK AND STONE;ROBERT K. ROTH, ESQ., 150 W. JEFFERSON, SUITE 2500, DETROIT, MI, 48226, US

(73) Assignee: Springthrough Consulting, Inc., Grand Rapids, MI (US)

(21) Appl. No.: 12/258,763

(22) Filed: Oct. 27, 2008

Related U.S. Application Data
(60) Provisional application No. 60/982,809, filed on Oct. 26, 2007.

(51) Int. Cl. G06Q 30/00

(52) U.S. Cl. 705/14; 705/1

(57) ABSTRACT

A method for providing consumers notification from an offering that vendors provide comprising the steps of providing an intermediary between consumers and vendors, wherein personal information about the consumer is provided to the intermediary, establishing desired notification parameters of the consumer, and assigning a filtered identification corresponding to each consumer. The filtered identification is used by the intermediary to send the offering from the vendor to the consumer. Either the consumer selects the amount of personal information included with the filtered information provided to the vendor, or the vendor selects the members which can view the offering.

### RELATED APPLICATION

This application claims priority benefit of U.S. provisional patent application No. 60/982,809 filed on Oct. 26, 2007.

### FIELD OF THE INVENTION

This invention relates to a centralized notification system, and more particularly to a centralized notification system which allows consumers to control how and when they receive notifications from vendors and service providers.

### BACKGROUND OF THE INVENTION

Vendors and service providers such as doctors, dentists, barbers, hair salons and other vendors and service providers have their staffs spend considerable time contacting customers reminding them of upcoming appointments. Also, customers/consumers of the goods and services of such vendors spend time repeatedly providing contact information to multiple vendors, which is inefficient. Such dissemination of contact information also raises privacy concerns.

Various scheduling and reminder networks and programs are known. For example, U.S. Pat. No. 6,760,412 to Loucks discloses a remote reminder scheduling program where reminders are sent to a person's computer or phone. However, Loucks does not provide for customer control to protect the privacy of the customer.

U.S. Pat. No. 7,188,073 to Tam et al discloses an online appointment system with electronic notifications providing reminders for scheduled offerings. However, the system is limited to reminders for scheduled offerings and does not provide a centralized system where the consumer's private information may be protected.

U.S. Pat. No. 7,042,989 to Lawson et al shows a flexible call notification system. A subscriber implements and accesses a telecommunications services using a graphical user interface and internet connection. The user can schedule, create and edit call notification messages which can be sent to multiple customers/recipients at a designated time. Again the system does not provide a centralized system where the consumer's private information may be protected.

U.S. Patent Publication 2001/0011247 to O'Flaherty et al discloses a privacy card. A customer orders a card and is queried on initial parameters for personal information and privacy preferences. A customer unique proxy is generated and stored in a database warehouse. The consumer can control a metadata monitoring extension to trigger an notification when the customer's personal information is read from the database, written to the database or if other parameters are changed or accessed. However, this disclosure concerns itself principally with systems for better determination of customer purchasing habits by use of a card with which consumer purchases may be tracked and does nothing to help reduce the amount of time and effort consumers and vendors must spend to record customer information and provide timely notifications.

It would be desirable to provide a convenient system where a consumer can securely indicate to vendors how and when the consumer would like to be notified of upcoming offerings.

### SUMMARY OF THE INVENTION

In accordance with a first aspect, a method for providing consumers notifications from an offering provided from vendors which comprises the steps of providing an intermediary between consumers and vendors, wherein personal information about the consumer is provided to the intermediary, establishing desired notification parameters of the consumer, and assigning a filtered identification corresponding to each consumer. The filtered identification is used by the intermediary to send the offering from the vendor to the consumer. Either the consumer selects the amount of personal information included with the filtered information provided to the vendor, or the vendor selects the members which can view the offering.

From the foregoing disclosure and the following more detailed description of various preferred embodiments it will be apparent to those skilled in the art that the present invention provides a significant advance in the technology of consumer notification systems. Particularly significant in this regard is the potential the invention affords for providing an easy to use system which both allows consumers to control how and when they are notified of vendor offerings while limiting the amount of personal information provided to the vendors. Additional features and advantages of various preferred embodiments will be better understood in view of the detailed description provided below.

### BRIEF DESCRIPTION OF THE DRAWINGS

FIG. 1 is a schematic chart of a system for allowing consumers to control how and when they are notified by service providers and other vendors.

FIG. 2 shows how the website acts as a filter, limiting and controlling direct communication between the vendors and the customers.

FIG. 3 is a table showing types of offerings and associated privacy settings.

FIG. 4 is a flow chart showing an overview of how a vendor or service provider sends out a communication for an offering (a notification), and how a user or member of the system selects offerings which the user wants to receive.

FIG. 5 shows a schematic interaction diagram between the components of the system.

FIG. 6 shows several ways of locating offerings from vendors.

FIG. 7 shows an offering process in accordance with a preferred embodiment.

FIG. 8 shows a flow chart highlighting member/user subscription privacy levels.

FIG. 9 shows a preferred embodiment for member/user sign up to the system.

It should be understood that the appended drawings are not necessarily to scale, do not necessarily include all the system components required for an actual implementation and present a somewhat simplified representation of various preferred features illustrative of the basic principles of the invention. The specific design features of the system for notification of consumers as disclosed here, including, for example, the specific user interface, will be determined in part by the particular intended application and use environment. Certain features of the illustrated embodiments have been enlarged or distorted relative to others to improve visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the system for notification of consumers disclosed here. The following detailed discussion of various alternative and preferred features and embodiments will illustrate the general principles of the invention with reference to notifications from service providers. Other embodiments suitable for other applications will be apparent to those skilled in the art given the benefit of this disclosure.

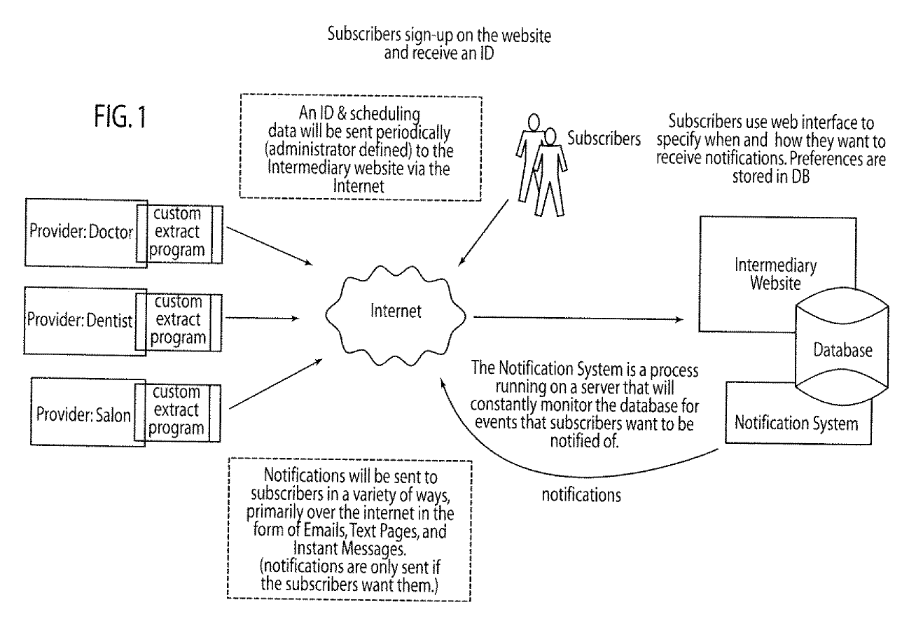

Referring now to the drawings, FIG. 1 shows a representative schematic of a centralized notification system which allows consumers to control how service providers send notifications. Such service providers can comprise, for example, doctors, dentists, barbers, hair salons, etc., but also non-profit organizations, hospitals and government agencies. Advantageously, the system places control of notification into the hands of the subscribing consumers and allows them to maintain a controlled level of anonymity with their vendors. For example, consumers do not have to give their phone number, e-mail address or other contact information to every vendor they do business with. Rather, such personal information is provided to an intermediary, typically a company which provides a website and filtered identification for each consumer. The intermediary's website, the vendor and the consumers are all connected via the internet. Consumers/users/subscribers subscribe to the website. Vendors also subscribe to the website.

The website is established which is accessible both by subscribing consumers or subscribers, and separately by vendors of services and/or goods. Subscribers log on initially and set up notifications for any providers they choose to work with. The subscriber is assigned a filtered identification which can comprise, for example an alphanumeric ID or e-mail address. The filtered ID is stored on the website. Vendors transmit scheduling/notification data to the intermediary website via the internet. Notification schedules can be adjusted pursuant to the needs of the subscribers and also by the settings of the vendors.

Preferably there is no cost to consumers to register and to obtain a filtered ID. Each vendor/provider may be charged a fee for use of the common notification system. Also, as shown in FIG. 1, a custom extract program may be used with each vendor to allow the vendor to easily input data reminding a customer of an upcoming offering or notify them to other news. The filtered information may be adjusted for each vendor. Notifications of upcoming offerings can be sent in one or more of a number of ways, including e-mails, text messages, instant messages, phone messages, etc.

A database of information about each consumer/subscriber's preferences is stored, preferably remote from each vendor/supplier/provider. The database would be connected to each vendor via the internet. Consumers would access the system by logging onto a website and specify how and when they want to receive notifications from vendors.

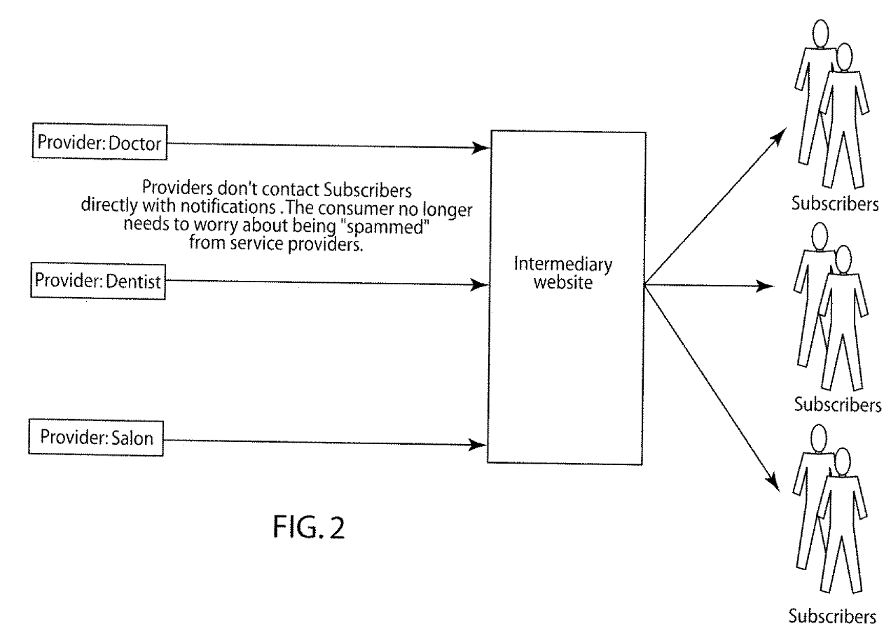

The notification system is run on a server that will constantly monitor offerings established by the vendors and placed on the database, and then send notifications or reminders in the format requested by each consumer. Advantageously, the service providers do not contact subscribers directly with notifications of offerings. Rather, the intermediary website only provides filtered information about subscribers to vendors. Typically this means that the customer is identified by alphanumeric identification, advantageously providing for control by the customer of distribution of notifications. FIG. 2 shows an example where a filtered identification is used to prevent providers such as doctors, dentists, salons, etc., from knowing the personal information of subscribers to the intermediary's service. This prevents the vendors/providers from sending additional unwarranted solicitations, and also prevents such vendors from providing personal information to other vendors, who might attempt to contact the consumer with their own solicitations. Thus, the consumer/subscriber only needs to provide a pre-selected identifier without additional identification, and does not need to worry about being spammed—i.e., receiving unwanted solicitations from other vendors.

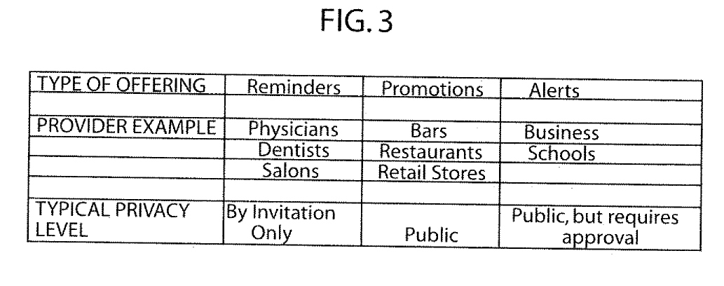

FIG. 3 is a table showing three kinds of offerings: reminders, promotions and alerts. Typically the only information the vendor would have been provided (under the system for consumers it wishes to send a reminder to) is the consumers preselected identifier and the knowledge that the consumer can be alerted using the intermediary website. Vendors comfortable with such an arrangement can comprise physicians, dentists, salons, etc. Public offerings are notifications which are made freely available to all consumers, not just those that choose to receive them. Of course, a consumer can control the filtered information so that they do or do not receive such promotions. With public offerings all consumer who have registered with the intermediary can view the offering supplied by the vendor. The third group of notifications is alerts. With approval required offerings, the registered consumers may make a request to receive an offering, and the vendor chooses whether to accept the request of the consumer. Any offering, regardless of whether it is a reminder, a promotion or an alert can be set to any privacy level.

As an example of the various kinds of offerings, a school may want to communicate information about school closings or emergencies to parents and other interested parties. The school may also wish to send notifications to only its employees. In this case, two kinds of offerings may be created: a School/Closing & Emergency offering which would be an Alert designated with a “Public” privacy level and therefore available to all subscribing consumers, and a Staff Alert offering which can be an Alert designated with an “Approval Required” privacy level. The school can screen subscribers and prevent them from viewing the message without proper identification, such as, for example, supplying a valid employee identification number.

As another example, a physician's office may choose to issue notifications in the form of reminders, with control of access retained exclusively by the vendor/physician. More specifically, a physician's office may choose to issue notifications in the form of reminders set to the “Invitation Only” privacy level. The consumer/patient may be required to meet with the physician and provide identification allowing the physician to correlate a correct patient record with the particular patient. The physician would use this information to generate a unique invitation identifier (such as a number) for the patient. Once this is accomplished, the patient can subscribe to the intermediary website, enter the invitation number and receive reminders from the physician.

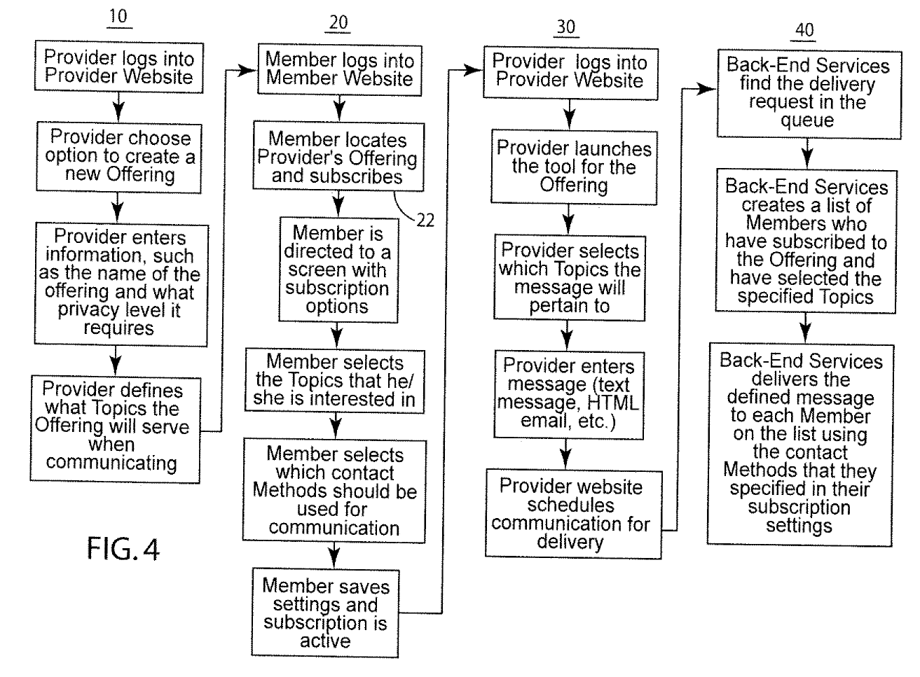

FIG. 4 shows the communications offering process from a provider to a member in accordance with a preferred embodiment. As a first step 10, a provider would log into the provider website. That is, a provider website is a website which is part of the intermediary and accessible primarily by the intended providers of notifications and notifications. After logging in, the provider will be presented with a series of screens which allow him to create a new offering/notification. The provider enters information about the notification. This typically comprises the name of the offering and what privacy level is required, as well as what topics the offering will include when sent to subscribers.

As a second step 20, consumers subscribe at a member website and become members or subscribers. The member website is preferably also part of the intermediary. Subscribing can include, for example, providing a home address, a work address, a telephone number, one or more e-mail addresses, or instant message contact information. Once subscribed and logged in, the member can locate a provider's offering and subscribe 22. On the website, the subscriber/member may preferably be directed to a screen with one or more subscription options. The member may select the topics that the member is interested in. This establishes notification parameters of the consumer/subscriber. Next the subscriber/consumer establishes the contact method for receiving the notification of the offering. Once the member saves his selected settings (including notification parameters and privacy levels, where applicable) the subscription becomes active.

At step 30, the provider can log into the provider website and launch a tool for notification of any one of the three kinds of offerings: reminders promotions and alerts. The provider/vendor selects a topic the offering or message will pertain to The offering may be in any of a variety of formats, including plain messages (text message, HTML, e-mail, etc.) or may have additional graphics. The provider website takes this offering and schedules it for delivery to consumers. At step 40, back-end services of the intermediary website receive a delivery request for the notification. The back-end service creates a list of members/subscribers who have subscribed to receive the offering. The back-end service delivers the notification to each specified member using the contact method specified by the subscriber established in their subscription settings.

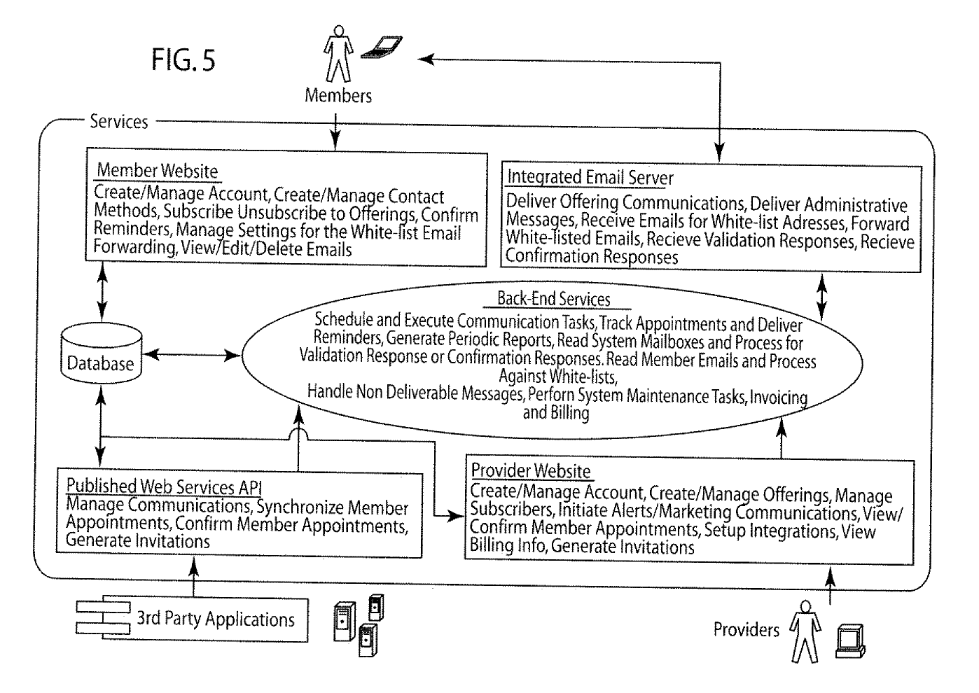

FIG. 5 shows how the back-end service of the intermediary website interacts with both the member and the provider website, along with other components of the system. The member website, as discussed earlier, creates and manages a subscriber/members account, contact methods (notification parameters), whether a member want to subscribe or unsubscribe to an offering, confirm notifications (including reminders, promotions and alerts), manages setting for white-list e-mail forwarding (that is, a group of vendors who are permitted to transmit notification of offerings) and allows for view/edit/delete of messages. The provider website creates/manages a provider/vendor's account, creates and manages offerings, manages subscribers, initiates notification (such as reminders, promotions and alerts), views and confirm members appointments, allow the vendor to view billing information (as vendors may be charged a fee for using the system or for subscribing to the system) and to generate notifications. All of this information is stored in a database. An integrated e-mail server delivers notifications of offerings, administrative message, receives e-mails for a white-listed addresses, forwards white-listed e-mails, receives validation response and receives confirmation responses. Back end services integrate the member website, provider website and integrated e-mail server and perform at least the following tasks: schedule and execute communication tasks, track appointments, deliver notifications, generate reports, read system mailboxes and process for validation response of confirmation responses. Back end services also read member e-mails and a process against white-lists, handle non-deliverable messages, perform system maintenance tasks, invoicing and billing.

The published web services application programming interface (API) shown in FIG. 5 is an interface into the intermediary website that is published to the internet. The published web services API allows external programs to access the intermediary website and perform tasks such as sending message to subscribers and synchronizing member notifications, as well as confirm member notifications and generate invitations.

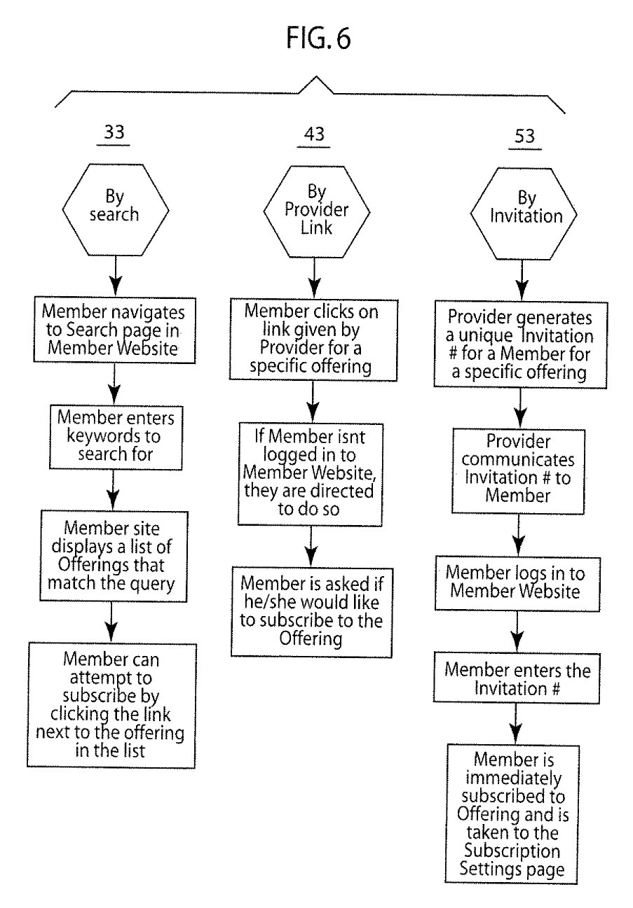

FIG. 6 shows several ways for a subscriber to locate and receive offerings from vendors, including a consumer initiated search 33, by vendor link 43, and by invitation of the vendor 53. By search, a member/subscriber navigates a search page in the member website. A keyword search is available. The member website can display a list of offerings that match a search query, and the member can attempt to subscribe by clicking a link on the website screen next to the listed offering. By provider link 43, the member clicks on a link given by a provider for a specific offering. If the member is not logged into the website, he is directed to do so. Once the member logs in, the member is then asked if he would like to subscribe to the offering. By invitation 53 the provider generates a unique invitation number for a member for a specific offering. The provider communicates the invitation number to the member. The member logs into the member website, enters the invitation number, and the member is subscribed to the offering and taken to a subscription settings page on the intermediary website.

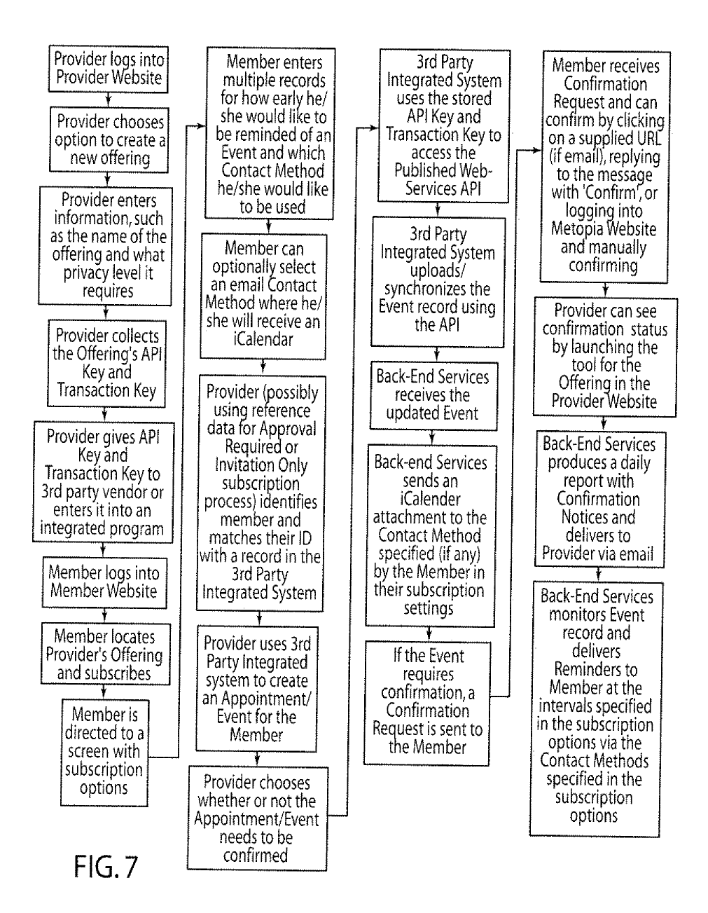

FIG. 7 is an example of the offering process. The provider logs into the provider website and creates a new offering, entering information about the offering and the privacy level, as discussed above. The provider now collects an offerings API key and a transaction key. When an external program accesses the published web services API, it must provide the offerings API key to identify the offering the external software wants to work with, and the transactions key, which acts as a password for that offering. Once this is completed, the member logs into the member website, is directed to a screen with subscription options, enters records for how the member would like to be reminded of an offering (provided notification) and which contact method the member would like used. For example, the member can select an e-mail contact where he receives an iCalendar notification. The provider identifies the member and matches his ID with a record from a third party integrated system. The provider uses the API to create a notification of the offering for the member. In the case of a reminder, this is an “event” or “event record” that is created for the member. The provider chooses whether or not the notification needs to be confirmed. The third party system uses the stored API key and transaction key to access the published web services API and upload the notification using the API. Back end services can send an iCalendar attachment in the contact method specified (if any) by the member in his subscription settings. If the notification requires confirmation, a confirmation request is sent to the member. When the member receives the confirmation request the member can confirm. Back end services can produce a daily report of confirmation notices and delivers this report to the provider. The back end services can also monitor notification records and deliver notifications to members at intervals specified in subscription options via the contact method specified in the notification parameter subscription options.

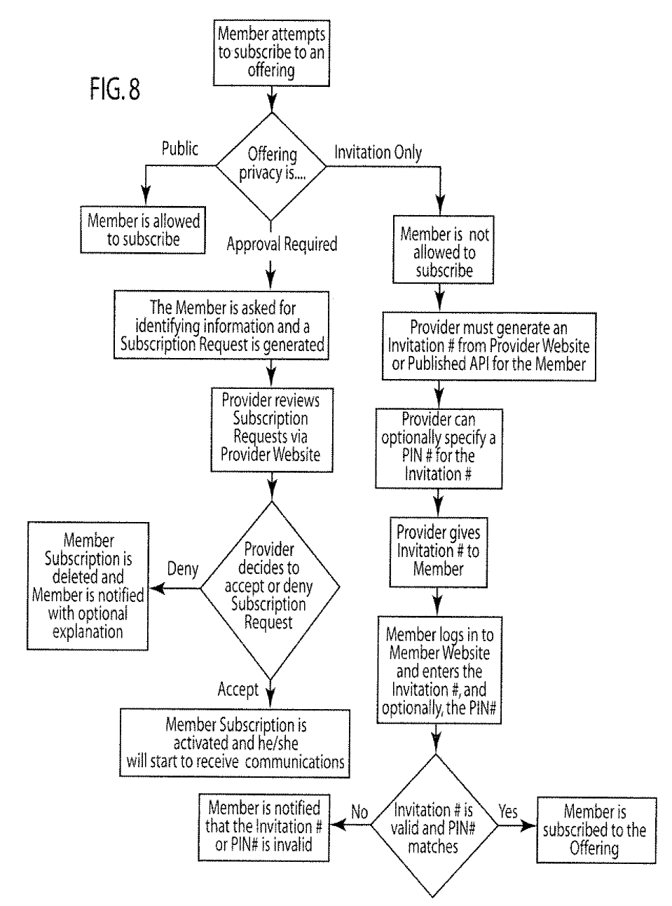

FIG. 8 shows examples of privacy levels used for establishing communication and filtered information pertaining to each consumer/subscriber. If the offering is public, then the member is allowed to subscribe to receive the promotion. For approval required offerings, the member is asked for identifying information and a subscription request is generated. Then the provider/vendor reviews the subscription request and chooses to accept or deny the request. If denied, the member subscription is deleted and the member may optionally be notified. If accepted, the member subscription is activated and the member will be able to receive communications. For offerings with an “Invitation Only” privacy level, a member is not allowed to subscribe directly. Rather, the provider must generate an invitation number and give this number to the member. The member logs into the website and enters the invitation number, and optionally an additional identifier, such as a pin number. If the invitation number is valid, the member is subscribed to the offering. If not, the member can optionally be notified that the invitation number or the pin number is invalid.

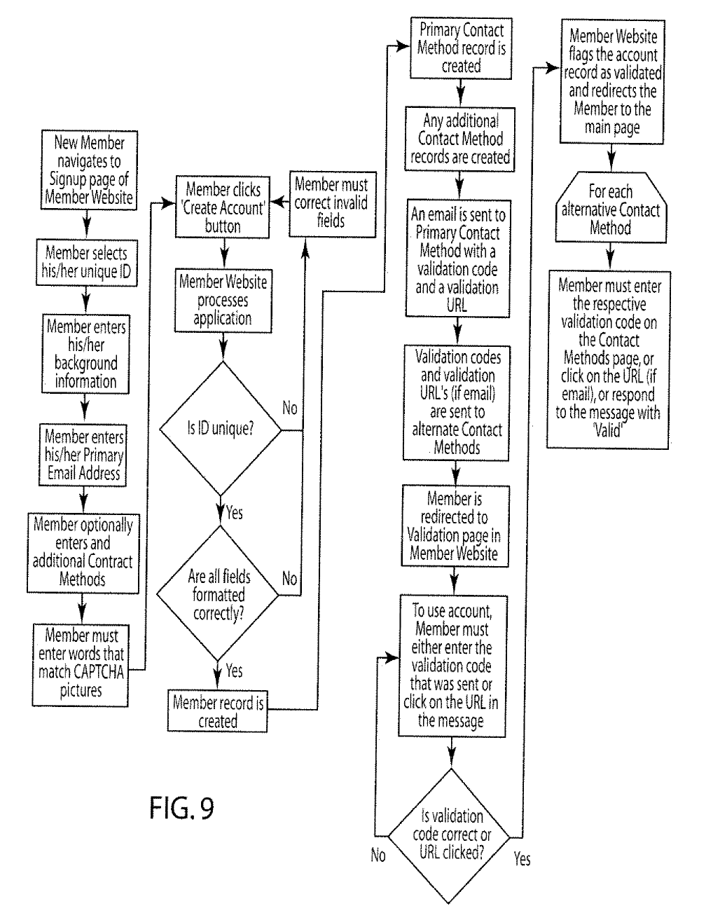

FIG. 9 shows a preferred method for a consumer to become a subscriber, that is, the sign up procedure. At the member website, prospective new members go to a signup page where as part of the signup process the new member select as unique ID. This unique ID serves as filtered identification of the subscribers to the vendors. The member also enters his contact information, which can include a name, address, e-mail, other contact information and other background information. Advantageously, the intermediary website may require the consumer to enter words that match CAPTCHA pictures. CAPTCHA pictures are used in challenge responses test to ensure that the response is not generated by a computer. The consumer must enter the words that correspond to the image that they see to continue to use the website.

Once the consumer has subscribed and the system has verified that the subscription is proper, the primary contact method of receiving the notification is created by the subscriber, along with any additional contact methods. Preferably a communication is sent to the primary contact (and any additional contacts) with a validation code and a validation URL. When the subscriber responds, he is redirected to a validation page on the member website. The member enters the validation code or clicks on the URL in the message. In response to proper validation, the member website flags the subscriber's account as validated and redirects the member to a main page of the member website. This process must be repeated for each of the alternate contact methods selected by the consumer.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method for providing consumers notifications from an offering provided by vendors comprising, in combination, the steps of:
providing an intermediary between consumers and vendors, wherein personal information about the consumer is provided to the intermediary;
establishing desired notification parameters of the consumer; and
assigning a filtered identification corresponding to each consumer, wherein the filtered identification is used by the intermediary to send the offering from the vendor to the consumer, wherein one of the consumer selects the amount of personal information included with the filtered information provided to the vendor, and the vendor selects the members which can view the offering.

2. The method of claim 1 wherein the personal information about the consumer comprises at least one of a home address, a work address, a telephone number, an e-mail address, and instant message contact information.

3. The method of claim 1 wherein the intermediary is a website operatively connected to the vendors and to the consumers via the internet.

4. The method of claim 1 further comprising the steps of:
registering the consumers up with the intermediary and having the consumers establish desired notification parameters; and
registering vendors with the intermediary;
wherein the vendors create a database of offerings and when a vendor wants to send the offering to the consumers, the offering is sent to the consumers using the filtered identification.

5. The method of claim 1 wherein the filtered information can be varied for each vendor.

6. The method of claim 4 wherein the offerings comprise reminders, promotions and alerts.

7. The method of claim 6 wherein with reminders the vendor controls which consumers can view the reminder, with promotions all consumer who have registered with the intermediary can view the promotion offered by the vendor, and with alerts the registered consumers may make a request to receive an offering, and the vendor chooses whether to accept the request of the consumer.

8. The method of claim 1 wherein each vendor is charged a fee for subscribing to the intermediary website.

9. The method of claim 1 further comprising an application programming interface for published internet services, which allows external programs access to the intermediary website.

10. The method of claim 1 wherein offerings from vendors are received by the consumer in response to at least one of a consumer initiated search, by vendor link, and by invitation of the vendor.
